(19) United States
(12) Patent Application Publication
(10) Pub. No.: US 2013/0239429 A1
(43) Pub. Date: Sep. 19, 2013

(54) Micro-encapsulated Chemical Re-application Method

(71) Applicants: Judy Vella, Upper Montclair, NJ (US); Thomas I. Marks, Memphis, TN (US)

(72) Inventors: Judy Vella, Upper Montclair, NJ (US); Thomas I. Marks, Memphis, TN (US)

(21) Appl. No.: 13/604,716

(22) Filed: Sep. 6, 2012

Related U.S. Application Data
(60) Provisional application No. 61/532,634, filed on Sep. 9, 2011.

(51) Int. Cl. A01N 25/28

(52) U.S. Cl. CPC A01N 25/28
USPC 34/282

(57) ABSTRACT

An application is provided that transfers volatile compounds encapsulated by a variety of methods to achieve a targeted release of those compounds to provide specific functional effects during normal use of the fabrics to which the encapsulated materials are transferred. This application is renewable and is typically performed during normal laundering of targeted fabrics.

### CROSS-REFERENCE TO RELATED APPLICATIONS

This application claims the benefit of U.S. provisional patent application Ser. No. 61/532,634, filed Sep. 9, 2011 by the present inventor.

### BACKGROUND

A variety of technologies has been developed to apply compounds to fabrics through the use of dryer sheets. The primary target to date has been to provide functional effect to the laundered fabrics, themselves.

Encapsulation on a substrate is offered in U.S. Pat. No. 6,689,740 (McGee, et. al.) to reduce loss of fragrance during manufacturing and to prolong its presence in treated goods. U.S. Pat. No. 7,723,286 (Fehr et. al.) identifies a method of controlled release of a perfume to provide a prolonged sensual effect, while U.S. Pat. No. 7,786,027 (Aouad, et. al.) discusses use of rupturing microcapsules to provide fragrance release upon folding, crumpling, etc.

Processes to add compounds such as fabric softener and fragrance to the laundered fabrics by use of dryer sheets are illustrated in U.S. Pat. No. 5,246,603 (Tsaur, et. al.). U.S. Pat. No. 6,277,796 (Sivik, et. al.) teaches the benefit of such addition for consumer acceptance of laundry products based upon the effected aesthetic properties including fabric softness, fragrance, and lack of static.

However, all of these previous efforts have focused on enhancement of the laundered products and the aesthetic perception of their cleanliness.

Many compounds have been identified as being capable of providing technical benefits without causing concern about the exposure hazards to humans and pets or the environment. Essential oils and floral essences, for example, offer a variety of benefits while still being identified as natural and safe.

Some of these essential oils and floral essences, alone or in combination with each other, have provided effective results in product areas such as pesticides and aromatherapy. However, these products normally require direct spraying of liquids onto surfaces to achieve a desired effect. Direct spray application can result in potential staining of fabrics, increased hazard to poor control of dosage, and a requirement for direct and active involvement in the treatment process at the time of desired efficacy.

One recent example of the use of essential oils to provide a pesticide benefit is the product Rest Easy from RMB Group. Testing of this blend of four essential oils has been found to provide very rapid kill of highly resistant bedbugs (90% in about two seconds), with additional repellency offered for a period of about seven to fourteen days (80% affected). Further, this combination of essential oils is exempt from U.S. EPA registration under FIFRA 25(b). This product, though, is provided to consumers to be applied to surrounding surfaces with a trigger sprayer. When using a sprayer, soaking surfaces or other factors can lead to potential concerns of consumer skin or sensual irritation with over-application.

The leading alternative for direct pesticide treatment of fabrics is associated with pyrethrins and pyrethroids. Even though these compounds do not exhibit the concern over volatility inherent with essential oils, their easier tendency to remain with an on surfaces for prolonged periods is not helpful. These compounds also exhibit extremely heavy health and safety concerns, including neurotoxicity and endocrine disruption. Additionally, the pyrethrins and pyrethroids have been shown in laboratory work to be inconsistent in their kill and repellant efficacy.

Another application area for liquid spray is aromatherapy. Many examples of documented health benefits have been achieved through either effect by aromatic stimulation of the brain or absorption into the body and bloodstream. Like the pesticide applications, aromatherapy currently requires direct effort at the time of desired effect, with a substantial potential for inconsistent and over-application. The only existing options known to the applicant for application of aromatherapy include aerial diffusion, direct inhalation, and topical applications.

Key problems with developing a useful application method for these compounds include their high volatility and low water solubility. With limited water solubility, they are difficult to disperse during the washing portion of laundering while still being susceptible to the rigors of detergent removal. With their high volatility, the laundry dryers can ten to drive off any treatment to the surrounding atmosphere rather than the targeted fabric. Additionally, some application methods, such as with moisture release, can not be simply added to portions of the laundering/cleaning process where water is present—contact with the water would lead to total release of the compounds during, for example, the washing process, leaving no remaining residual to provide the desired effect.

Accordingly, there is a need in the art for novel methods and compositions to conveniently and consistently transfer these beneficial compounds to fabrics from which they can be released at the appropriate and necessary time.

### SUMMARY OF INVENTION

The appropriate blends of volatile, yet very limited water solubility, compounds 10 are encapsulated by methods(s) that allow optimum release of those compounds under targeted conditions such as humidity and friction as described herein. The encapsulated compounds are preferably blended in a ratio to maximize the controlled release of the entrapped compounds. Micrometer Laboratories of Dayton, Ohio uses micro-encapsulation technology such as described above to encapsulate compounds for the applicant, to have desired proper as will be discussed below.

This blended ratio of encapsulated compounds is then applied to a substrate, typically non woven, by spraying, dipping, or other coating methods to achieve the designed coat and active ingredient weight per unit area. If not 100% of one oil, blended ratios can be 100% oils such as about 80% cinnamon, about 6% lemongrass oil, about 6% clove oil and about 6% mint oil or other combination of oils and/or other ingredients. The resultant encapsulation-treated substrate serves as a dryer sheet to be added to rotary dryers during normal laundering of targeted fabrics (multiple sheets can be used together to achieve a higher dosage or handle larger laundry loads). Dryer bars can also be provide din some embodiments as substrates.

These treated fabrics then, during their normal storage and use, allow for the release of the entrapped compounds during exposure to conditions anticipated during specific treatment design. Upon release of those volatile compounds, their technical effect can be manifested upon the people, pets, or surfaces in the area surrounding the treated fabric.

In products designed to offer a pesticidal kill and/or repellency, the released compounds are mechanically “metered” out to provide protection during, for example, prolonged storage, expanded exposure to human activity, etc. Metering can be accomplished by determining the amount of desired solution per square foot of fabric and applying a suitable amount to the substrate to accomplish this objective based on release methods known in the substrate industry. For products intended to provide aromatherapy, these compounds are released upon removal from storage of the treated products, placement or donning of fabrics and clothing, and during usage of the treated goods.

Appropriate combinations of encapsulation release, such as moisture and friction/pressure, are developed to customize the control to targeted storage and use conditions. As an example, moisture release may be considered more of a steady time-release action that will occur during storage or idle presence, while friction/pressure release will occur during unfolding and installation of the fabrics, long with periods of human contact and movement.

The instant invention addresses these and other needs by providing a convenient and flexible method for treatment and re-treatment of fabrics using a simple dryer sheet addition during normal maintenance and upkeep activities of laundering or cleaning.

### BRIEF DESCRIPTION OF THE DRAWINGS

The particular features and advantages of the invention as well as other objects will become apparent from the following description taken in connection with the accompanying drawings in which:

FIG. 1 is a perspective view showing application of encapsulated compounds to a substrate; and

FIG. 2 is a perspective view showing the use of the substrate to transfer encapsulated compounds to fabric in a clothes dryer.

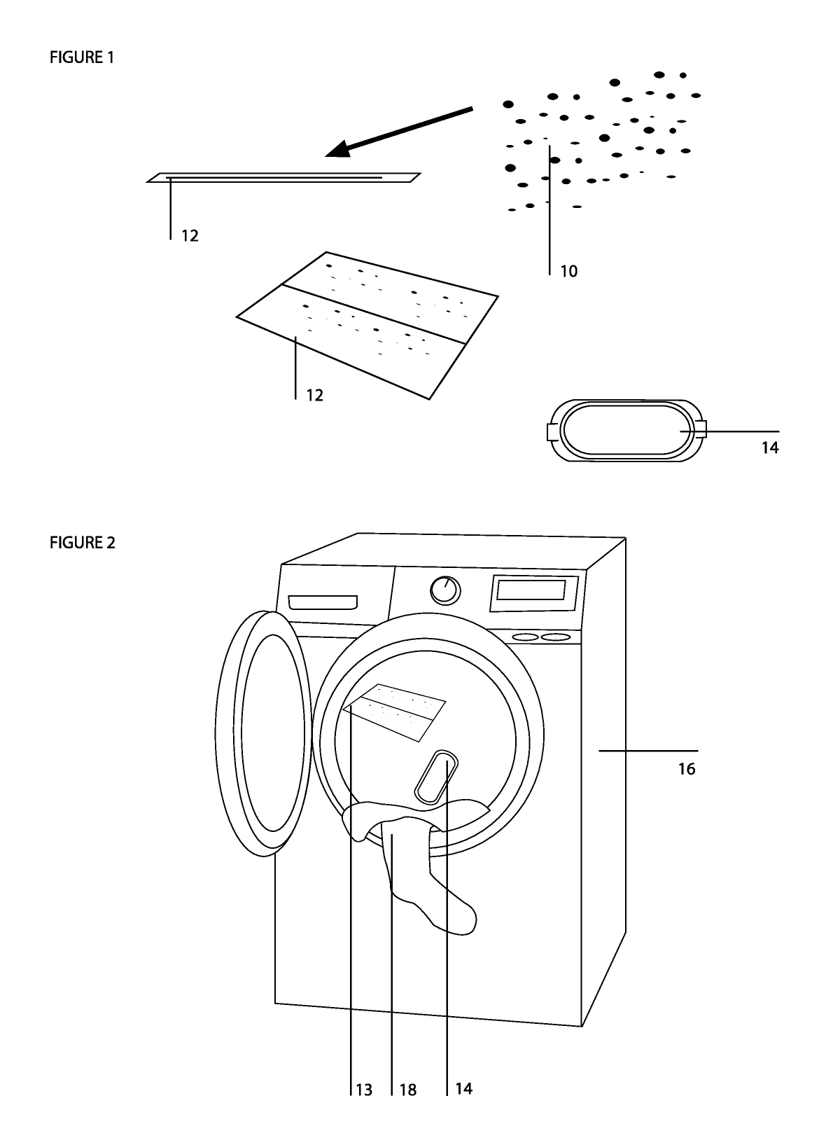

### DETAILED DESCRIPTION OF PREFERRED EMBODIMENTS

In a broad aspect, the invention provides a method of application of encapsulated volatile compounds 10 to targeted fabrics 18 and the products formed from them. Specific combinations of variously formed encapsulations are used to control the conditions under which the compounds are released. These combinations are often dipped, sprayed, or coated by convenient and appropriate methods onto substrates 12, typically non woven, that are subsequently used as dryer sheets 13 in rotary, laundry dryers 16. Other applications and techniques may be used in other embodiments. The encapsulated compounds 10 transferred from the dryer sheets 13 to the fabrics 18 during the dryer cycle then are available to be released under pre-designed conditions that may occur during storage and use of the treated goods. Dryer bars 14 may also be used as substrates 12. Dryer bars 14 normally differ from dryer sheets 13 as they are intended for multiple and usually successive drying operations whereas most dryer sheets 13 are believed to be single use. However, dryer bars 14 or dryer sheets 13 can have multiple or single uses. Furthermore, dryer bars 14 may or may not be fixedly connected internal to a dryer 16 during use whereas dryer sheets 13 are normally tossed in with a load of laundry.

Accordingly, in one embodiment, the encapsulated compounds 10 are a blend of essential oils that provides pesticidal activity. In a preferred embodiment, at least one encapsulated component 10 is an essential oil. Suitable essential oils include, without limitation, cinnamon oil, lemongrass oil, clove oil, mint oil, and any combination thereof. A combination of these four identified essential oils provides a superior effect in killing a broad spectrum of insects such as bedbugs and mosquitoes, mites, and spiders. Other blends and/or oil or oils may be used for other pesticidal applications. With the protection of the treated fabrics while in proximity and/or contact with humans a common concern, the blend of encapsulation choices can be focused more heavily on friction/pressure release to capitalize on the movement and pressure that would occur during actual use, and a lighter focus on moisture release that will provide a lower, ongoing treatment level to reduce the risk of infestation during storage for a least some embodiments. Other embodiments may take other considerations into effect and possibly provide other constructions.

In another embodiment, individual essential oils or combinations thereof are encapsulated to achieve targeted aromatherapy benefits. In one preferred embodiment, lemon oil is used to provide anti-stress/anti-depression benefits. Without limitation, the encapsulated material 10 could be used to treat bed linens and night clothes to provide a more relaxing and peaceful sleep. With the target to address persons who may be under stress and possibly more subject to sweating, the blend of encapsulation methods may shift toward a higher contribution by moisture release to offer a higher concentration of essential oil during such possible stressful episodes.

The composition according to the instant invention has several important features which render it superior to currently used methods of application. In additional to reduced loss and waste of efficacy during prolonged periods of storage, the release of the encapsulated volatile compounds can be custom-designed to achieve the highest level of exposure during specific times or conditions that would demand such. Furthermore, this technology reduces the risk for overexposure that may be used by other methods to ensure adequate treatment at sometimes unpredictable time factors. Also, this methodology allows a convenient and flexible re-treatment when treated goods have undergone extremely long or rigorous storage conditions or simply after use.

The patent and scientific literature referred to herein establishes the knowledge that is available to those with skill in the art. All United States patents and published or unpublished United States patent applications cited herein are incorporated by reference. All published foreign patents and patent applications cited herein are hereby incorporated by reference. All other published references, documents, manuscripts and scientific literature cited herein are hereby incorporated by reference.

While this invention has been particularly shown and described with references to preferred embodiments thereof, it will be understood by those skilled in the art that various changes in form and details may be made herein without departing form the scope of the invention encompassed by the appended claims.

What is claimed is:

1. A method of re-applying an encapsulated compound comprising the steps of:
applying a designed blend of encapsulated compound to a substrate as a carrier of the encapsulated compounds, for use as one of a pesticide and aromatherapy; and then
drying a fabric with the substrate in a dryer thereby transferring the compound to the fabric in the dryer in a effective amount to perform a desired effect selected from the group of providing a pesticide and an aromatherapy effect.

2. The method of claim 1 wherein the substrate is a non-woven selected from the group of natural, synthetic, and regenerated fibers.

3. The method of claim 1 wherein the substrate is selected form the group of woven fabrics, foam, and sponges.

4. The method of claim 1 wherein the encapsulated compound is applied to the substrate through spraying, dipping, and other coating.

5. The method of claim 1 wherein the encapsulated compound is one of solvent-based, water-based, and dry powder-based as applied to the substrate.

6. The method of claim 1 whereby the encapsulated compounds are volatile essential oils and floral essences selected from the group of bergamot oil, cedar oil, chamomile oil, cinnamon oil, citronella oil, clove oil, eucalyptus oil, frankincense oil, garlic oil, geranium oil, ginger oil, lavender oil, lemon oil, lemongrass oil, lime oil, mandarin oil, melissa oil, mint oil, myrrh oil, orange oil, oregano oil, patchouli oil, peppermint oil, rose oil, rosemary oil, rosewood oil, sesame oil, spearmint oil, thyme oil, and wintergreen oil.

7. The method of claim 1 with the substrates used are dryer sheets, whereby the encapsulated compounds are transferred to fabrics during the drying phase of normal laundering and cleaning processes in the dryer.

8. The method of claim 1 wherein the substrate provided is a dryer bar.

9. The method of claim 7 with the transferred encapsulated compounds whereby they provide a functional effect by the targeted release of the encapsulated compounds to the environment and/or to individuals in proximity to the fabric.

10. The method of claim 9 whereby optimum release is designed to provide appropriate benefit as determined by factors including but not limited to time, relative humidity, prolonged effect, continuous effect, and conditions of fabric storage and use.

11. The method of claim 10 with the intended effect being to offer pesticidal activity such as kill and/or repellency of organisms including but not limited to insects such as bedbugs, dust mites, bacteria, fungi, and viruses.

12. The method of claim 10 with the intended effect being to provide aromatherapy to persons exposed to the released compounds.

13. The method of claim 1 may have a variety of targeted release mechanisms including but no limited to moisture, pH, pressure/friction, and temperature. The selected targeted release mechanisms are chosen for their contribution of characteristics to the overall strategy to provide optimum release of the encapsulated compounds necessary to provide the intended effect.

14. The method of claim 3 to which the encapsulated compounds are transferred during the drying phase of laundering may include but are not limited to cotton, cotton/poly blends, linen, cotton/viscose blends, cotton/rayon blends, wool, polyester (microfiber), cotton poplin, cotton sateen, cotton batiste, and cotton lawn.

15. The method of claim 1 to which the encapsulated compounds are transferred to one of bed sheets, pillowcases, blankets (filled and non-filled), comforters, mattress pads, pillow protectors, featherbeds, mattress and box spring encasements, duvet covers and shams, body pillows, body pillow covers, travel blankets, travel pillows, sleepwear, pajamas, loungewear, intimate apparel, underwear, and chemises (sleep dresses) during the drying phase of laundering.
